(19) United States
(12) Patent Application Publication
(10) Pub. No.: US 2010/0031322 A1
(43) Pub. Date: Feb. 4, 2010

(54) SECURE PRINTING METHOD

(75) Inventor: Hiroki Yuasa, Nagaokakyo (JP)

Correspondence Address: Locke Lord Bissell & Liddell LLP;Attn: IP Docketing, Three World Financial Center, New York, NY, 10281-2101, US

(73) Assignee: IBM Corporation, Armonk, NY (US)

(21) Appl. No.: 12/183,640

(22) Filed: Jul. 31, 2008

(51) Int. Cl. G06F 21/00

(52) U.S. Cl. 726/4

(57) ABSTRACT

A method for secure printing comprising receiving a user print request to print information from a computer terminal, wherein the computer terminal is located in a network and is assigned an internet protocol address, prompting the user for approval to instruct a designated printer to commence printing the print request, wherein the designated printer is connected to a network and is assigned an internet protocol address, determining whether the computer terminal and the designated printer are in the same network by comparing the first portion of the computer terminal's internet protocol address with the first portion of the designated printer's internet protocol address, and instructing the designated printer to commence printing if the computer terminal and the designated printer are determined to be in the same network.

### FIELD

Management and protection of personal information, and more particularly, secure printing.

### BACKGROUND

Privacy and security is a concern in office environments where documents that contain confidential or proprietary information are frequently created, edited and revised. Despite adequate protections taken to restrict access to certain computer files via passwords and other types of access-based security, documents must often be printed in the office environment. Office environments today typically connect multiple computers together over a network that may itself cover multiple offices throughout multiple cities or even countries. The networks connect together multiple computers, but also multiple printers, most of which can be designated as a printing destination for any personal computer station used by a user (PC). When a user instructs a PC to print a document, often the user is prompted to approve printing from a default-designated printer. Without careful consideration, however, it remains possible that the default printer selected is in another area of the user's office, or perhaps even in another office. For printed documents that contain confidential or private information, users may inadvertently print this information to faraway, unsecured areas that render the information susceptible to conversion. Security for printed documents in large firms with a variety of levels of access is not alleviated by identification passcards that restrict physical access to a given office. Offices remain populated not only by employees of a given firm, but also by employees of the building, temporary employees, as well as employees from affiliated or even competing companies that can easily gain visitation rights with little or no oversight once they are there. In addition, due to the ease required to print documents from a PC, employees often inadvertently print documents without retrieving them from the printer for several hours if not days. Unmanned documents containing confidential or private information exacerbate security concerns.

One method that exists in the art for protecting printed documents containing confidential information requires equipping the printers with magnetic card readers and/or scanners and equipping the user with a pass-card. In the event a user prints a confidential document from a designated printer, the printer only prints the document after the user scans a passcard thereby confirming it is the user who is requesting the document and who is standing by the printer ready to retrieve it once it is printed. This method, however, requires extra investment into expensive physical security measures that can be financially unfeasible for many businesses. In addition, this method burdens users by requiring that each user wait by a printer during printing of a document, which in addition to being a hassle, wastes time.

### SUMMARY

The foregoing problems are addressed by a method for secure printing that comprises receiving a user print request to print information from a computer terminal, wherein the computer terminal is located in a network and is assigned a non-static internet protocol address by a dynamic-host-configuration-protocol server each time the computer terminal connects to the network, and wherein the computer terminal's internet protocol address is subnet mask having a first portion designate a network address and a second portion designate a host address; prompting the user for approval to instruct a designated printer to commence printing the print request, wherein the designated printer is connected to a network and is assigned a static internet protocol address, and wherein the designated printer's internet protocol address is subnet mask having a first portion designate a network address and a second portion designate a host address; receiving approval from the user to commence printing from a designated printer; determining whether the computer terminal and the designated printer are in the same network by comparing the first portion of the computer terminal's internet protocol address with the first portion of the designated printer's internet protocol address; instructing the designated printer to commence printing if the computer terminal and the designated printer are determined to be in the same network; prompting the user for approval to instruct the designated printer to commence printing if the computer terminal and the designated printer are determined not to be in the same network, wherein, if at any time, the computer terminal does not receive user approval to instruct the designated printer to commence printing after prompting the user for the approval, then the print request is canceled.

### BRIEF DESCRIPTION OF THE DRAWING

FIG. 1 is a flowchart illustrating the steps followed in performing a secure printing method.

### DETAILED DESCRIPTION OF THE DISCLOSURE

By way of an overview, this invention is directed to a method for secure printing by determining whether a designated printer is safe for using as a printing destination by judging whether the designated printer and the user's PC are both within the same network or sub network.

Initially, at some point before a print request is received by a designated printer from a user's PC, the user's PC is connected to an in-company network. In one embodiment, PCs and printers are connected through a local area network, but this invention is not limited to use within any specific type of network. For the purposes of this invention, a network can comprise any version of a group of interconnected computers, including, without limitation, a local area network (LAN). When a user's PC is connected to a network in an office environment, rather than assigning a fixed IP address to the PC, a non-static IP address is assigned by a dynamic-host-configuration-protocol (DHCP) server each time the PC connects to the network. Printers, on the other hand, connected to an in-company network are assigned static or fixed IP addresses, which are used when settings for the printer are configured on a PC.

The IP addresses assigned to PCs and printers connected to an in-company network based upon the internet-protocol suite (which contains the Transmission Control Protocol and the Internet Protocol) designate a subnetwork, or subnet, that identifies the network or portion of the network that is connecting a group of PCs, printers and/or other network-connected devices. PCs and printers within the same network will have IP addresses with common routing prefixes. The routing prefix is the sequence of bits of an IP address that designates the network and precedes the portion of the IP address that designates the host. In some installations, the routing prefix is expressed as a “subnet mask”, which is a bit mask that designates how many bits are used in the prefix. Depending on the complexity and size of a given network, routing prefixes can be subdivided into the network identifier and the subnet identifier, where the subnet identifier identifies a subnetwork within the network.

In one embodiment, subnet masks are expressed as quad-dotted decimal representation and they are equivalent to Class C. Accordingly, they are represented by the form “NNN.NNN.NNN.NNN”, where “N” can typically be a value within the range of 0 through 9. The values of “NNN”, however, are restricted to the range 1 through 255, which approximates 2 to the eighth power, where a given group of “NNN” can have the value of 1, without any corresponding zeros. In Class C, the first three groups of “NNN” are used to designate the address of the network, and the fourth group of “NNN” is used to designate the address of the host, where the host includes the PC or the printer. Accordingly, for a given network, 255 network devices, or hosts, can be connected together. In an alternate embodiment, however, the first two groups of “NNN” designate the network, the third group of “NNN” designates the subnetwork, and the fourth group of “NNN” designates the host. It will be appreciated by one of ordinary skill in the art that subnet masks can be expressed in forms other than quad-dotted decimal representations, and this invention is not limited to such representations, but rather, this invention can be used with subnet masks of any version or form provided they appropriately identify the network and/or subnetwork to which a given PC or printer belong.

It has been observed that companies often designate networks and subnetworks to share physical proximity. Accordingly, a given network or subnetwork will comprise a group of PCs, printers and other devices located on a certain floor or located within a specific area of an office. In addition, it is rare that a network or subnetwork will be assigned to a group of devices that span more than one building or office, which would therefore require a user to leave his or her building in order to retrieve a document that has been selected for printing.

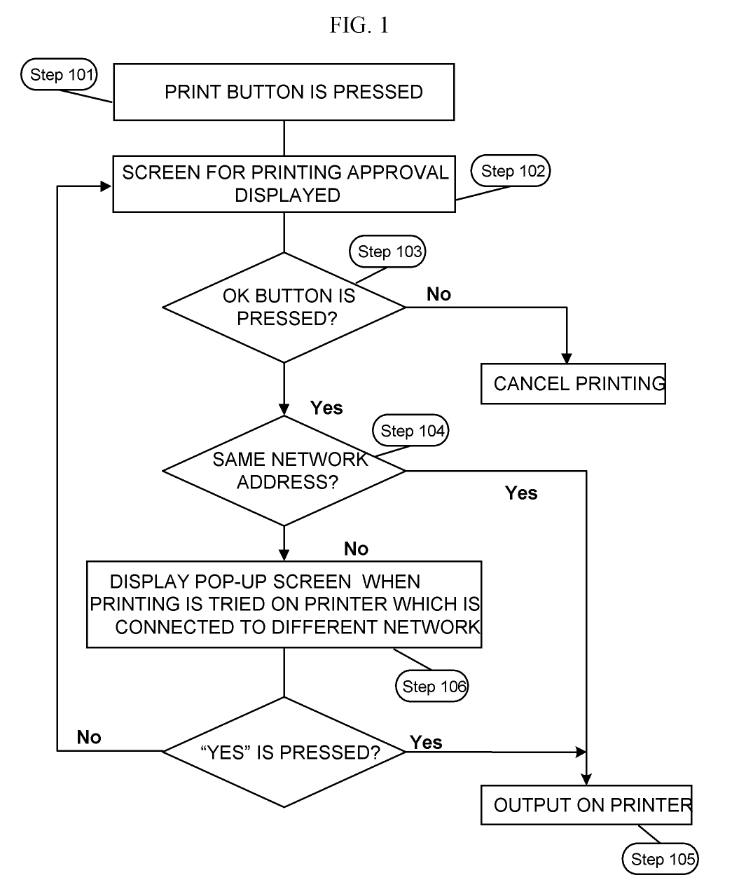

Turning to the drawing, FIG. 1 is a flow chart illustrating the steps of the secure printing method. In Step 101, a printer receives an instruction from a PC to print a selected document. While most office environments use WindowsXP as their operating system, this invention is not limited to the use of WindowsXP, any version of Windows or any specific operating system. Nor is this invention limited to any specific means, methods or devices used for a PC to instruct a printer to print a selected document or for the designated printer to carry out the operation of printing a selected document once instructed. Rather, one of ordinary skill in the art will appreciate that all operating systems used within office environments contain means and mechanisms for printing selected documents.

In Step 102, the user is prompted for approval to print the selected document. Again, whereas most office environments use WindowsXP, or some version of Windows operating system, this invention is not limited to any specific means or mechanisms for prompting a user for approval to commence printing a selected document. In one embodiment, a a prompt screen appears on the user's PC's monitor that contains an “OK” button that is to be pressed in the event that the user grants approval that the selected document be printed. In addition, often said screen indicates that a default printer has been selected as a printing destination for the selected document, and by pressing the “OK” button, the user simultaneously instructs the printer to commence printing as well as printing from the designated default printer. The foregoing is merely an illustration of one embodiment of the invention. It will be appreciated by one of ordinary skill in the art that different means and mechanisms exist in the art for prompting the user for approval to print a selected document from a designated default printer that may or may not involve prompting the user to press an “OK” button. Moreover, this invention is not limited to prompting the user's approval to print a selected document through use of an “OK” button.

In Step 103, it is determined whether the user has granted approval for the designated printer to commence printing the selected document. If approval is not granted, then the printing request is canceled and the selected document is not printed. In one embodiment, approval is not granted by, for instance, the user failing to press the aforementioned “OK” button within a pre-determined period of time. In this embodiment, a clock-function is used to measure a predetermined amount of time between receipt of the user's instruction to print a selected document and receipt of an instruction that the user has pressed the “OK” button. In the event the predetermined amount of time expires without receipt of an instruction that the “OK” button has been pressed, then the print request is canceled. It will be appreciated by one of ordinary skill in the art that different mechanisms and means exist for determining whether a user has failed to grant approval to commence printing a selected document after being prompted for approval.

On the other hand, in the event that the user grants approval to print the selected document from the designated printer by, for instance, pressing the “OK” button within the predetermined period of time, then in Step 104, it is determined whether the user's PC and the designated printer are within the same network. In one embodiment, judgment of whether the user's PC and the designated printer are within the same network, and therefore, presumably within a physical proximity that will afford safe and secure printing, is achieved by comparing the network identifier of the IP address of the user's PC to the network identifier of the IP address of the designated printer. If the two network identifiers are identical, then it is determined that the user's PC and the designated printer are within the same network. By way of an example, if the user's PC has been assigned an IP address that is 9.188.100.10 and the designated printer has been assigned an IP address that is 9.188.100.234, then it will be determined that the PC and the printer are within the same network because they contain identical network identifiers, i.e., 9.188.100. However, if the two network identifiers are not identical, then it is determined that the PC and the printer are not within the same network.

In an alternate embodiment, the subnet mask is divided into a network identifier and a subnetwork identifier. In this embodiment, rather than determining whether the user's PC and the designated printer are within the same network, it is determined whether they are within the same subnetwork. By way of an example, if the user's PC has been assigned an IP address that is 9.188.100.10 and the designated printer has been assigned an IP address that is 9.188.101.234, then it will be determined that the PC and the printer are not within the same subnetwork because although they share identical network identifiers (9.188), they do not share identical subnetwork identifiers (100 for the PC and 101 for the printer).

It will be appreciated by one of ordinary skill in the art that the demands of different office environments and the desire to reduce bottlenecking that can result from disproportionate distribution of PCs and printers within a single network will dictate that networks be divided and subdivided into subnetworks. Accordingly, based upon the desired level of security desired by a given office environment, judgment as to whether a designated printer is safe and secure for printing a document containing confidential or private information can be determined at the network level or the subnetwork level or at additional sub-network levels, as desired by the user.

In the event it is determined in Step 104 that the user's PC and the designated printer are within the same network or subnetwork, as the case may be, then in Step 105, the designated printer will commence printing the selected document without any further approval or instruction by the user. On the other hand, if it is determined in Step 104 that the user's PC and the designated printer are not within the same network or subnetwork, then in Step 106, the user is prompted for approval to commence printing the selected document from the designated printer that has been judged not to be within the same network. In the event that the user's approval to commence printing is not received by, for instance, the use of a clock-function that measures a predetermined period of time that begins after prompting the user for approval to print from the designated printer, as described above, then a screen prompting the user to print from a different printer is displayed, and the method returns to Step 102. In an alternate embodiment, in the event that the user's approval to commence printing is not received by, for instance, the use of a clock-function that measures a predetermined period of time that begins after prompting the user for approval to print from the designated printer, as described above, then the print request is canceled. In no event, after prompting a user for approval to commence printing, will printing commence if approval has not been received.

It will be appreciated by persons skilled in the art that the present disclosure is not limited to what has been particularly shown and described herein. Rather, the scope of the present disclosure is defined by the claims which follow. It should further be understood that the above description is only representative of illustrative examples of implementations suitable for use with the invention.

1. A method for secure printing comprising:
receiving a user print request to print information from a computer terminal,
wherein the computer terminal is located in a network and is assigned a non-static internet protocol address by a dynamic-host-configuration-protocol server each time the computer terminal connects to the network, and
wherein the computer terminal's internet protocol address is subnet mask having a first portion designate a network address and a second portion designate a host address,
prompting the user for approval to instruct a designated printer to commence printing the print request,
wherein the designated printer is connected to a network and is assigned a static internet protocol address, and
wherein the designated printer's internet protocol address is subnet mask having a first portion designate a network address and a second portion designate a host address,
determining whether the computer terminal and the designated printer are in the same network by comparing the first portion of the computer terminal's internet protocol address with the first portion of the designated printer's internet protocol address,
instructing the designated printer to commence printing if the computer terminal and the designated printer are in the same network,
prompting the user for approval to instruct the designated printer to commence printing if the computer terminal and the designated printer are judged not to be in the same network,
wherein, if at any time, the computer terminal does not receive user approval to instruct the designated printer to commence printing after prompting the user for the approval, within a predetermined period of time measured by use of a clock-function, which begins after prompting the user to print from the designated printer, then the print request is canceled.
